(19) United States
(12) Patent Application Publication
(10) Pub. No.: US 2014/0280710 A1
(43) Pub. Date: Sep. 18, 2014

(54) GATEWAY SYSTEM AND PROCESS FOR IP ENABLED DEVICES

(71) Applicant: GREENMETRIC L.L.C., Minneapolis, MN (US)

(72) Inventors: James D. Wilson, Plymouth, MN (US); Yunsha He, Chanhassen, MN (US)

(73) Assignee: GREENMETRIC L.L.C., Minneapolis, MN (US)

(21) Appl. No.: 13/837,317

(22) Filed: Mar. 15, 2013

(51) Int. Cl. H04L 29/08

(52) U.S. Cl. CPC H04L 67/02
USPC 709/217

(57) ABSTRACT

A computer implemented method is provided for monitoring and controlling a plurality of internet protocol (IP) enabled devices on a network. Each of the plurality of IP enabled devices has an internal IP address on the network, but does not have an external IP address for use on the Internet. The method includes the step of performing a port scan to obtain internal IP addresses for the plurality of IP enabled devices on the network. An HTML page is retrieved from each of the plurality of IP enabled devices on the network using the internal IP addresses. A data file name is extracted from each of the retrieved HTML pages and in some embodiments is translated to a new data file name. The method also includes retrieving data from each of the plurality if IP enabled devices on the network as a function of the extracted data file names or using the new data file names. Computer readable storage medium and gateway computing devices, for example in the form of a plug computer, are also disclosed.

### BACKGROUND OF THE INVENTION

The present invention relates to communication and control of Internet Protocol (IP) enabled devices from a cloud based or other remotely located computing or control center.

Green technologies are increasingly important in generating energy and in reducing energy consumption. In order to monitor or control such green technologies, IP enabled sensors, transducers and control devices are proving to be valuable tools. For instance, in heating, ventilation, and air conditioning (HVAC) systems and other environmental controls, IP enabled temperature sensors, humidity sensors, duct sensors, thermostats and other monitoring or control devices can be used to intelligently control the HVAC system or environmental control system components in a manner which achieves a desired result using less energy than would be used in a conventional system. The IP enabled devices are able to log data, receive commands, and otherwise communicate over a network, such as wireless network or a local area network (LAN). Other types of IP enabled devices are also used in other technology areas, providing significant performance improvements as compared to conventional non-IP enabled devices.

Increasingly, cloud based computing centers are being used to store data, implement data processing functions, and provide remote monitoring and other functions. Using such cloud based centers or services to monitor or control remotely located IP enabled devices provides great opportunity. Likewise, other non-cloud based remote monitoring or control of IP enabled devices can be beneficial. One problem encountered when employing large numbers of IP enabled devices and monitoring or controlling them from a remote location outside of a company or business is the availability and expense of external IP addresses for the devices. When available from regulatory authorities, obtaining external IP addresses can add significantly to operational costs. For a company that might employ hundreds or even thousands of IP enabled devices, the costs could be prohibitive. Further, in many countries IP external addresses are assigned by a government agency and are assigned only sparingly. Obtaining a single external IP address can be challenging, and obtaining large numbers of external IP addresses is not possible or practical. Without each IP enabled device having an external IP address, being able to control the devices over the internet or cloud is problematic.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computer implemented method is provided for monitoring and controlling a plurality of internet protocol (IP) enabled devices on a network. Each of the plurality of IP enabled devices has an internal IP address on the network, but does not have an external IP address for use on the Internet. The method includes the step of performing a port scan to obtain internal IP addresses for the plurality of IP enabled devices on the network. An HTML page is retrieved from each of the plurality of IP enabled devices on the network using the internal IP addresses. A data file name, for example an XML file name, a JSON file name, or a customized file name, is extracted from each of the retrieved HTML pages. In some embodiments, the data file name is then used to lookup the model information from a cloud database that will return a translated data file name to be used. The translated data file name may or may not be different than the data file name in the HTML. In other embodiments, no data filename translation is required. The method also includes retrieving data (for example XML data for an XML file name) from each of the plurality if IP enabled devices on the network using the translated data file names, the extracted data file names or using other techniques and criteria which are based on or a function of the extracted data file names. Computer readable storage medium and gateway computing devices, for example in the form of a plug computer, are also disclosed.

### BRIEF DESCRIPTION OF THE DRAWINGS

FIG. 1 is a block diagram illustrating an example embodiment of a gateway computing device configured in accordance with exemplary embodiments.

FIG. 2 is a block diagram of a system utilizing the gateway computing device of FIG. 1 to provide self-discovery of IP enabled devices on a network and to communicate data from the IP enabled devices to a cloud computing center and to receive device commands in response from the cloud computing center.

FIGS. 3 and 4 are block diagrams illustrating methods and processes in accordance with exemplary embodiments.

FIGS. 5-1 through 5-3 provide an illustration of example XML data retrieved from one particular type of an IP enabled device in an exemplary embodiment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected,” “coupled” and variations thereof are used broadly and encompass both direct and indirect connections and couplings. Further, “connected” and “coupled” are not restricted to physical or mechanical connections or couplings.

Exemplary embodiments of the disclosed invention preferably operate in a suitably programmed computer such as a plug computer configured as a gateway computing device for communicating with a cloud based processing center. Plug computers, which are small form factor computer servers often enclosed in an AC power plug or AC adapter, are well known in the art and are particularly well suited for disclosed embodiments. However, disclosed embodiments can be in other computing environments such as a personal computer, a mobile computer, and other types of server computers, to name but a few examples.

Although not required, the invention is described in the general context of computer-executable instructions, such as program modules, being executed by an electronic device. Generally, program modules include routines, programs, objects, components, data structures, etc. that perform particular tasks or implement particular abstract data types. In embodiments, the invention may be practiced in distributed computing environments where tasks are performed by remote processing devices that are linked through a communications network. In a distributed computing environment, program modules may be located in both local and remote memory storage devices.

FIG. 1 shows an exemplary device 100 for implementing an embodiment of the invention. While in exemplary embodiments device 100 is a plug computer type of server computer, device 100 can be other types of computers and is therefore described in the context of a general computing device. In its most basic configuration, the computing device 100 includes at least a processing unit 102 and a memory 104. Depending on the exact configuration and type of computing device, the memory 104 may be volatile (such as RAM), non-volatile (such as ROM, flash memory, etc.) or some combination of the two. This most basic configuration is illustrated in FIG. 1 by a dashed line 106.

Additionally, the device 100 may also have additional features/functionality. For example, the device 100 may also include additional storage (removable and/or non-removable) including, but not limited to, magnetic or optical disks or tapes, USB flash drives, memory cards, etc. Such additional storage is illustrated in FIG. 1 by a removable storage 108 and a non-removable storage 110. Computer storage media includes volatile and nonvolatile, removable and non-removable media implemented in any method or technology for storage of information such as computer readable instructions, data structures, program modules or other data. The memory 104, the removable storage 108 and the non-removable storage 110 are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can accessed by the device 100. Any such computer storage media may be part of the device 100.

In the description that follows, the invention will be described with reference to acts and symbolic representations of operations that are performed by one or more devices, unless indicated otherwise. As such, it will be understood that such acts and operations, which are at times referred to as being computer-executed, include the manipulation by the processing unit of the device of electrical signals representing data in a structured form. This manipulation transforms the data or maintains it at locations in the memory system of the device, which reconfigures or otherwise alters the operation of the device in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

System memory 104 may include operating system 130, one or more programming modules 132, and program data 134. Operating system 130, for example, may be suitable for controlling computing device 100's operation. As stated above, a number of program modules 132 and data files 134 may be stored in system memory 104, including operating system 130. While executing on processing unit 102, programming modules 132 may perform processes including, for example, one or more methods of self-discovery of IP enabled devices and communicating with a cloud computing center or other device in a manner which provides commands to individual IP enabled devices without requiring separate external IP addresses for each device.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The device 100 may also contain one or more communications connections 112 that allow the device to communicate with other devices. The communications connections 112 can include, for example, wired media connections such as a wired network or direct-wired connection, and wireless media connections such as acoustic, RF, infrared and other wireless media connections. In exemplary embodiments, communications connections 112 are configured to provide communication between device 100 and other computing devices 150 over a computer network 152 such as the Internet. In some exemplary embodiments in which device 100 is a plug computer, instead of communication connections 112 connecting directly to Internet or network 152, communication connections 112 can include one or both of USB communication circuitry and wireless communication circuitry for communicating through network routers and other server computers which provide the connection to the Internet or other computer network 152.

In some embodiments the computing device 100 has a display device 116 which can be coupled to device 100 for programming device 100, for viewing data, or for other purposes. The device 100 may also be coupled to one or more input devices 114, such as a keyboard, mouse, pen, voice input device, etc., for providing input to the computing device. The device 100 may be coupled to one or more other output devices 118 such as speakers, a printer, a vibration generator, etc. All these devices are well known in the art and need not be discussed at greater length here. Further, display device 116, input devices 114 and output devices 118 can all be considered to be separate from, or alternatively part of, computing device 100. Display device 116, input devices 114 and output devices 118 are also not required in all embodiments.

Computing device 100 can be provided with a portable OR non-portable power source 120, such as a battery pack, a transformer, a power supply, or the like. The power source 120 provides power for computations, communications and so forth by the device 100. In exemplary embodiments in which device 100 is a plug computer, power source 120 has an associated plug apparatus for plugging device 100 directly into an AC power outlet.

Referring now to FIG. 2, shown in block diagram form is a system 201 which utilizes a gateway computing device and methods in accordance with disclosed embodiments described below. At a business, commercial location or other facility which uses IP enabled devices 210 such as temperature sensors, thermostats, or other types of sensors, actuators, controllers, etc., system 201 can be utilized to monitor and control the IP enabled devices. System 201 includes the IP enabled devices 210, coupled to a corporate or other computer network 215 by one or more routers 205. Routers 205 can be wireless routers, Ethernet coupled routers, optical fiber connected routers, or other types of routers. A firewall 200, for example implemented in a server computer, has a connection or output port 222 to Internet 152 or other computer network which couples network 215 and system 201 to a cloud based computing center 250.

A gateway computing device 100, for example in the form of a plug computer as discussed above, is configured to be coupled to network 215, for example through a router 205, to provide functionality which allows monitoring and control of IP enabled devices 210 from cloud computing center 250 without the IP enabled devices having external IP addresses. Network 215 is typically a corporate network at a facility where IP enabled devices 210 are installed and network 215 is coupled through an output port 222 of server 200 to internet 152. Through the internet connection, network 215 is coupled to a remotely located cloud computing center 250. The cloud computing center 250 can be configured with enterprise service and web service software which are configurable to implement portions of disclosed embodiments. Also provided by cloud computing center are databases 260 which store data, such as sensor data from IP enabled devices, and rules engine software 265 which processes the data from devices 210 to determine what control commands to transmit back to network 215. Cloud computing center 250 also provides websites 270 which are accessible by an authorized person using a web browser 280 on a remote computer. Browser traffic 275 represents the data transmission between the remote computer and the cloud computing center 250.

Gateway computing device 100 includes software or module(s) 202 which configure the computing device to implement self-discovery methods for automatically identifying IP enabled devices 210 on the network, and extracting information identifying the characteristics of the IP enabled devices from the data (for example XML data) stored in the devices. Gateway computing device 100 also includes software or module(s) 204 which configure the computing device to use web service communication with a cloud computing center 250 to provide data from devices 210 to the cloud computing center, and to receive commands for the devices 210 from the cloud computing center, without the need for external IP addresses for each device 210.

Referring now to FIGS. 3 and 4, shown are flow diagrams which embody methods of self-discovery of IP devices 210 and web service communication as shown at modules 202 and 204 of FIG. 2. Self-discovery method 300 shown in FIG. 3 includes steps which are similar or the same as self-discovery method 400 shown in FIG. 4, and these steps are designated with identical reference numbers. Certain of the general steps shown in FIG. 3 have more specific example steps shown in FIG. 4. These steps share similar designations (e.g., 325 vs. 425).

As shown at 305, the self-discovery process starts at some predetermined time or upon some triggering event. In exemplary embodiments, the self-discovery process for discovering IP devices on the local network runs at start-up and occurs every time gateway device 100 boots. The process can also be repeated at other predetermined intervals or occur with other triggering events. The self-discovery process is used to verify response matches (for example response XML matches) correspond to expected types of devices. At step 310, gateway computing device 100 retrieves or identifies the device port 312 through which the IP enabled devices 210 communicate. In one particular embodiment as illustrated in FIG. 4, the step 410 of retrieving or identifying the device port includes getting the device port 312 from a gateway configuration file. The gateway configuration file could exist in many forms such as residing in a physical file on the gateway computing device 100 or in the cloud database(s) 260. The device port can also be obtained through a webservice.

Next, at step 315, the methods include performing a port scan on device port 312 to obtain a list of internal IP addresses 317 for the devices 210 on network 215. For each of the internal IP addresses, an HTML page is retrieved from memory of the corresponding device 210. In this process, at step 320 it is determined whether any further internal IP addresses are available on the list, or whether all internal IP addresses have been processed. If this question is answered in the affirmative, at step 325, for each internal IP address the process retrieves or obtains the HTML page 327 from the corresponding device 210 using that internal IP address. In one particular embodiment shown in FIG. 4, step 425 achieves this by navigating to the home page, named start.html, of the device 210 at each IP address. However, in other embodiments, simply navigating to the internal IP address will default to the default or home HTML page of the device 210. Thus, it is not necessary to know the particular home page naming convention used by the manufacturer of devices 210 in order to retrieve the HTML pages 327 of the devices.

Next, using the HTML page obtained for each IP device 210 (i.e., the HTML page at each of the IP addresses in list 317), the data file name 332 (an XML file name in the following examples) is extracted from the HTML page. This is shown at step 330 in FIG. 3. Different methods of extracting the XML file name can be used. For example, as shown at step 430 in FIG. 4, a search of the HTML page can be performed for a particular line of code using a “find” command if particular naming conventions are used by a device manufacturer and are known by developers of gateway device 100. In one example, a “find” command search for “Object.open” will result in the identification of the line containing the data file name (e.g., the XML file name) 332. In another embodiment, a search is conducted for a string of text to identify the line with the XML file name and the XML file name is extracted from the line. In the example shown in FIG. 4, the file name for one HTML page is shown to be “mt201.xml”, but this is simply an example to demonstrate an embodiment of such a process step. This XML file name 332 can also be translated to a translated XML file name that is obtained from the cloud database(s) 260. An example is translating “mt201.xml” to “mt201ext.xml”. It must be understood that while XML file names and XML data are used in the following examples, the disclosed embodiments can be used on other data file names besides XML file names, and data other than XML data can be retrieved using the file name. For example, JavaScript Object Notation (JSON) file names can be extracted and data from a JSON file can be retrieved. Other custom data file types can also be handled using the disclosed methods. The following discussion in the context of XML file names and data must be understood to cover other types of file names and data as well.

Once the XML file name (e.g., including translated or other derivations of the XML file name) 332 is known for the device 210 corresponding to each internal IP address identified using the port scan, at step 335 the XML file name (or some derivation thereof) is used to retrieve the XML data for that device. This can be accomplished using various techniques. In the example embodiment shown in FIG. 4, at step 435 gateway device 100 retrieves the XML data using the command line “http://<Ipaddress>:<port>/<xml filename>.xml” where “Ipaddress” is the internal IP address identified in the port scan for the device in step 315, “port” is the device port 312 identified in steps 310 or 410, and “xml filename” is the XML file name extracted in steps 330 or 430 or a translation or derivation thereof. Other techniques for retrieving data such as XML data as a function of the data file name can be used. An example of the retrieved XML data for a device 210 is shown at FIGS. 5-1 through 5-3.

At step 340, a next internal IP address is retrieved from list 317 and the process repeats to retrieve XML data for the next device 210. If no more IP addresses are available in list 317, then at reference number 322, the process of self-discovery is completed and a method or process 350 of using web service communication to send the device data to cloud computing center 250, and of receiving device commands from the cloud computing center, is initiated.

As discussed above, disclosed embodiments provide a solution to the problem of conducting communication of IP enabled device data and commands between the devices and a cloud computing center when the IP enabled devices do not have unique external IP addresses. As discussed, disclosed embodiments send data obtained from the IP enabled devices 210 to the cloud computing center 250 in web service requests or calls 257 (see FIG. 2), and send commands back to the network 215 and gateway computing device 100 through a web service command 259 (see FIG. 2). This allows data to be communicated from, and commands to be provided to, many IP enabled devices with only a single external IP address for the network or system. The gateway computing device 100 provides the data (via router 205 and network 215 connections) to the web services 255 at the cloud computing center, and distributes the returning commands back to the individual IP enabled devices using their respective internal IP addresses. Referring again to FIGS. 3 and 4, this is shown in method or process 350.

Once process 300 has completed and there are no additional internal IP addresses determined at step 322, gateway computing device 100 gets the next file, from list 337 of files, at step 355. If it is determined at step or decision point 360 that there are data files containing device data (sensor readings, device states, etc.) to be sent, at step 370 the data for a particular file is sent in its own separate call 257 (see FIG. 2) to a web service 255. The call is shown in FIG. 3 as web service XML request 375. In other embodiments, data from more than one device can be sent in a single call, or data from one device can be sent in multiple calls. As shown at step 380 performed at the cloud computing center, the web services 255 store the data in databases 260, process the data with any applicable rules engines 265, and generate device commands in response for controlling the particular IP enabled device 210. The device commands are then sent back as a web service response 259. At step 385 implemented in gateway computing device 100, the device commands embedded in the web service response 259 are then posted to the particular device 210 using the devices internal IP address and port.

The above-described steps can be altered and/or supplemented with other steps for particular implementations. For instance, in some embodiments, for each device from which data was retrieved, the data is saved to a file in gateway device 100. Subsequent messages can then be compared to the previous messages, and only the messages in which the new data is different than the previous message (excluding time and date data) are sent to the cloud using process 350. Numerous other or different steps can also be implemented within the disclosed processes.

Although the present invention has been described with reference to preferred embodiments, workers skilled in the art will recognize that changes may be made in form and detail without departing from the spirit and scope of the invention.

What is claimed is:

1. A computer implemented method for providing monitoring and control of a plurality of internet protocol (IP) enabled devices on a network, the plurality of IP enabled devices each having an internal IP address on the network but not having an external IP address, comprising:
performing a port scan to obtain internal IP addresses for the plurality of IP enabled devices on the network;
retrieving an HTML page from each of the plurality of IP enabled devices on the network using the internal IP addresses;
extracting a data file name from each of the retrieved HTML pages; and
retrieving data from each of the plurality if IP enabled devices on the network as a function of the extracted data file names.

2. The computer implemented method of claim 1, wherein performing the port scan further comprises generating a list of internal IP addresses.

3. The computer implemented method of claim 2, wherein the steps of retrieving the HTML page, extracting the data file name, and retrieving the data are performed for one IP address at a time and are repeated for each internal IP address on the generated list of internal IP addresses.

4. The computer implemented method of claim 1, and further comprising, prior to performing the port scan, obtaining a device port on which the plurality of IP enabled devices communicate on the network, and wherein performing the port scan further comprises performing the port scan on the device port.

5. The computer implemented method of claim 4, wherein obtaining the device port further comprises obtaining the device port from one of a gateway configuration file, a database and a web service.

6. The computer implemented method of claim 1, wherein retrieving the HTML page from each of the plurality of IP enabled devices on the network using the internal IP addresses further comprises retrieving the HTML page from each of the plurality of IP enabled devices on the network using a default html page at each respective internal IP address.

7. The computer implemented method of claim 1, wherein retrieving the HTML page from each of the plurality of IP enabled devices on the network using the internal IP addresses further comprises retrieving the HTML page from each of the plurality of IP enabled devices on the network using a home page address for the corresponding internal IP address.

8. The computer implemented method of claim 1, wherein extracting the data file name from each of the retrieved HTML pages further comprises searching each retrieved HTML page for a string of text to identify a line with the data file name and extract the data file name from the line.

9. The computer implemented method of claim 1, wherein retrieving data from each of the plurality if IP enabled devices on the network using the extracted data file names further comprises, for each of the plurality of IP enabled devices, retrieving the data using the corresponding internal IP address and the corresponding extracted data file name for the IP enabled device.

10. The computer implemented method of claim 1, and further comprising sending retrieved data for each of the plurality of IP enabled devices from a gateway computing device of the network to a cloud computing center in one or more calls to a web service.

11. The computer implemented method of claim 10, and further comprising receiving device commands, from the cloud computing center, at the gateway computing device in one or more web service responses to the one or more calls.

12. The computer implemented method of claim 11, and further comprising posting device commands, received in the one or more web service responses, to individual ones of the plurality of IP enabled devices using the corresponding internal IP addresses of the individual ones of the plurality of IP enabled devices.

13. The computer implemented method of claim 1, and after extracting the data file name from each of the retrieved HTML pages, further comprising translating the data file name to a translated data file name, and wherein retrieving data from each of the plurality of IP enabled devices on the network as a function of the extracted data file names comprises retrieving the data from each of the plurality if IP enabled devices using the corresponding translated data file names.

14. A computer readable storage medium storing computer readable instructions which, when executed by a computer, cause the computer to perform steps comprising:
performing a port scan to obtain internal IP addresses for a plurality of IP enabled devices on a network;
retrieving an HTML page from each of the plurality of IP enabled devices on the network using the internal IP addresses;
extracting a data file name from each of the retrieved HTML pages; and
retrieving data from each of the plurality if IP enabled devices on the network as a function of the extracted file names.

15. The computer readable storage medium of claim 14, wherein retrieving the HTML page from each of the plurality of IP enabled devices on the network using the internal IP addresses further comprises retrieving the HTML page from each of the plurality of IP enabled devices on the network using a home page address for the corresponding internal IP address.

16. The computer readable storage medium of claim 14, wherein extracting the data file name from each of the retrieved HTML pages further comprises searching each retrieved HTML page for a string of text to identify a line with the data file name and extract the data file name from the line.

17. The computer readable storage medium of claim 14, wherein retrieving data from each of the plurality if IP enabled devices on the network as a function of the extracted data file names further comprises, for each of the plurality of IP enabled devices, retrieving the XML data using the corresponding internal IP address and the corresponding extracted data file name or a translated data file name for the IP enabled device.

18. The computer readable storage medium of claim 14, and wherein the steps further comprise sending retrieved data for each of the plurality of IP enabled devices from the network to a cloud computing center in one or more calls to a web service, receiving device commands, from the cloud computing center, at the network in one or more web service responses to the one or more calls, and posting device commands, received in the one or more web service responses, to individual ones of the plurality of IP enabled devices using the corresponding internal IP addresses of the individual ones of the plurality of IP enabled devices.

19. A gateway computing device for use with a system having a network and a plurality of internet protocol (IP) enabled devices on the network, the plurality of IP enabled devices each having an internal IP address on the network but not having an external IP address, the gateway computing device comprising:
a computer readable storage medium storing computer readable instructions which, when executed by the gateway computing device, cause the gateway computing device to perform steps comprising:
performing a port scan to obtain internal IP addresses for the plurality of IP enabled devices on the network;
retrieving an HTML page from each of the plurality of IP enabled devices on the network using the internal IP addresses;
extracting a data file name from each of the retrieved HTML pages; and
retrieving data from each of the plurality if IP enabled devices on the network as a function of the extracted data file names or a translation of the extracted data file names; and
a computer processor configured to execute the computer readable instructions to perform the steps.

20. The gateway computing device of claim 19, wherein the computer readable storage medium and the computer processor are included in a plug computer.
